(19) United States
(12) Patent Application Publication
(10) Pub. No.: US 2025/0317885 A1
(43) Pub. Date: Oct. 9, 2025

(54) SYSTEMS AND METHODS FOR SHARING NETWORK SUBSCRIPTIONS BETWEEN USER EQUIPMENT

(71) Applicant: Verizon Patent and Licensing Inc., Basking Ridge, NJ (US)

(72) Inventors: Shanthala KURAVANGI-THAMMAIAH, Keller, TX (US); Lalit R. KOTECHA, San Ramon, CA (US); Eugene A. CARUCCI, Oxford, NJ (US)

(73) Assignee: Verizon Patent and Licensing Inc., Basking Ridge, NJ (US)

(21) Appl. No.: 18/630,163

(22) Filed: Apr. 9, 2024

(51) Int. Cl. H04W 60/04; H04W 8/18; H04W 76/10

(52) U.S. Cl. CPC H04W 60/04; H04W 8/18; H04W 76/10

(57) ABSTRACT

In some implementations, a device may receive a request to share a network subscription of a first user equipment (UE) with a second UE, wherein the first UE is associated with a first network operator and the second UE is initially associated with a second network operator. The device may verify that the first UE is provisioned with a network subscription sharing capability that allows the first UE to share the network subscription with the second UE. The device may receive a request to register the second UE with the first network operator, wherein the request includes a credential that indicates a user class as a guest user. The device may transmit, based on the network subscription sharing capability of the first UE, a response that accepts a guest registration of the second UE with the first network operator, wherein the response provides a guest network subscription.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example signal flow associated with sharing network subscriptions between user equipments (UEs).

FIG. 2 is a diagram of another example signal flow associated with sharing network subscriptions between UEs.

FIG. 3 is a diagram of an example environment in which systems and/or methods described herein may be implemented.

FIG. 4 is a diagram of example components of one or more devices of FIG. 3.

FIG. 5 is a flowchart of an example process associated with sharing network subscriptions between UEs.

### DETAILED DESCRIPTION OF EXAMPLE EMBODIMENTS

The following detailed description of example implementations refers to the accompanying drawings. The same reference numbers in different drawings may identify the same or similar elements.

A wireless network may support various use cases that are associated with high bandwidth and low latency Such use cases may require all UEs involved to have a similar level of connectivity, data rate, jitter, and/or quality of service (QOS) to receive a desired level of user experience. When one of the involved UEs is associated with poor network quality, high latency, and/or low bandwidth, other UEs may be affected as well, thereby resulting in a poor user experience for all involved parties.

For example, a first UE may communicate with a second UE. A first user associated with the first UE may communicate with a second user associated with the second UE. When the second UE is associated with poor network conditions, communications from the first UE may not be received by the second UE or received after an inordinate amount of delay, and a user experience for the second user may be degraded. In addition, although the first UE may be associated with relatively good network conditions, the poor network conditions associated with the second UE may cause communications from the second UE to also not be received by the first UE or received after a certain amount of delay. As a result, even though the first UE may be associated with relatively good network conditions, a user experience of the first user may also be degraded.

In some implementations, a first UE associated with a first network operator may communicate with a second UE associated with a second network operator. Communications between the first UE and the second UE may be associated with an extended reality (XR) use case or any other type of use case. XR may include augmented reality (AR), virtual reality (VR), and/or mixed reality (MR). When the second UE is associated with poor network conditions on the second network operator, the first UE may invite the second UE to share the first UE's network operator subscription on the first network operator. The first UE may invite the second UE to share the network operator subscription in a dynamic or on-demand manner for a duration of a session. The first UE and the second UE may both benefit when both the first UE and the second UE are using the first network operator, as the first network operator may be associated with the relatively good network conditions, in relation to the second network operator. As another example use case, two people may be playing an electronic game from different places on gaming consoles or smartphones and share a subscription so the two people have the same experience (e.g., consistent data rates and/or jitter associated with the two UEs associated with the two people).

In some implementations, in order to support on-demand wireless subscription sharing, the first UE may have a capability to request to add a guest subscriber for a limited period of time, where the guest subscriber may be associated with the second UE. A network function, like an access and mobility management function (AMF) for example, may verify, based on signaling with a unified data management (UDM) and/or a unified data repository (UDR), that the first UE has a network sharing subscription (e.g., the first UE is authorized to share its network subscription with the second UE). The UDM and/or the UDR may generate an on-demand guest subscription for the second UE with a validity timer. The guest subscription may be limited to certain network services and/or a certain location. The second UE may have a capability to register with the first network operator. The second UE may have a capability to register with guest user credentials (e.g., an indication of a user class may be set to a guest user). The AMF for example, may recognize the second UE as a guest subscriber based on the second UE's guest user credentials, and may skip an authentication process for the second UE. The UDM and/or the UDR may recognize that the second UE's user class is set to the guest user, and the UDM and/or the UDR may provide the guest subscription based on the second UE's user class. The UDR may provide guest policy subscription information to a policy control function (PCF) when a packet data unit (PDU) session is established for the second UE.

In some implementations, by supporting on-demand wireless subscription sharing, the second UE may be able to utilize network capabilities of the first network operator when the second network operator associated with the second UE is associated with poor network conditions. The second UE may be able to improve its bandwidth and/or latency by being added as a guest subscriber to the first network operator, which may be associated with relatively good network conditions. As a result, an overall performance for the UE may be improved.

In some implementations, the first network operator may monetize on network coverage, quality, and/or resilience by sharing the network operator subscription without introducing subscriber churn (e.g., a number of subscribers that stop paying for a product or service in a given period of time). The first UE's ability to share the network operator subscription with the second UE may be a pay-per-use feature or a subscription or plan feature. The first UE's ability to share the network operator subscription with the second UE may provide a level field for users of XR use cases. Further, guest users may receive a demonstration of another network operator without having to purchase a wireless plan with the other network operator.

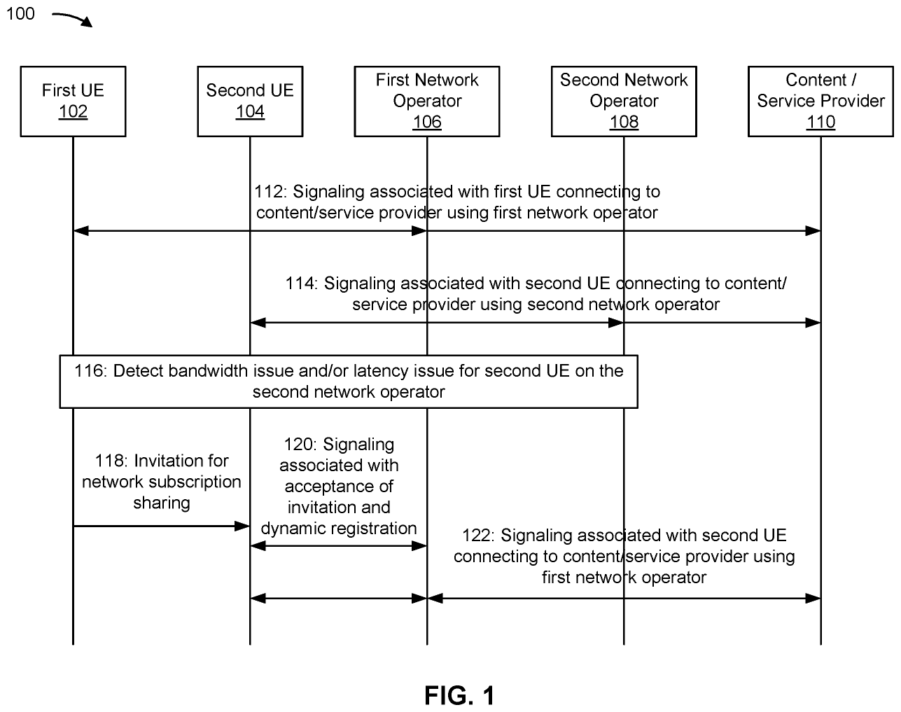

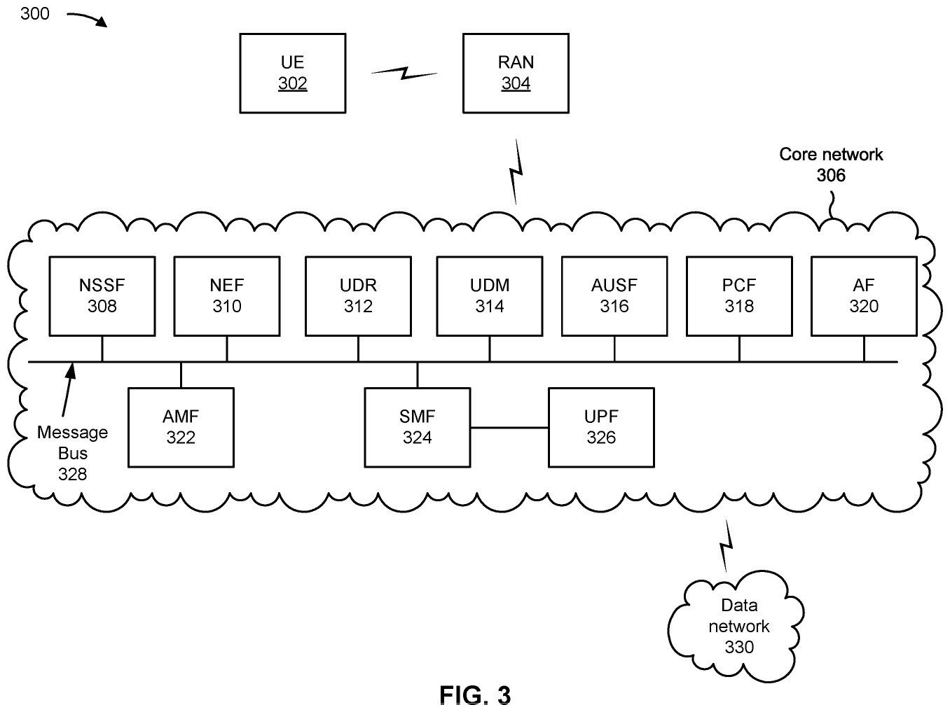

FIG. 1 is a diagram of an example 100 associated with sharing network subscriptions between UEs. As shown in FIG. 1, example 100 includes a first UE 102, a second UE 104, a first network operator 106, a second network operator 108, and a content/service provider 110. The first UE 102 and the second UE 104 may correspond to UE 302, as shown in FIG. 3. The first network operator 106 may be associated with a first network and the second network operator 108 may be associated with a second network. The first network operator 106 may be associated with a first network provider and the second network operator 108 may be associated with a second, different network provider.

As shown by reference number 112, the first UE 102 may transmit, to the first network operator 106, signaling to cause the first UE 102 to connect to the content/service provider 110 using the first network operator 106. The first UE 102 may connect to the content/service provider 110 using the first network operator 106.

As shown by reference number 114, the second UE 104 may transmit, to the second network operator 108, signaling to cause the second UE 104 to connect to the content/service provider 110 using the second network operator 108. The second UE 104 may connect to the content/service provider 110 using the second network operator 108.

As shown by reference number 116, the first UE 102 and/or the second UE 104 may detect a performance issue associated with the second UE 104 and/or the second network operator 108. The first UE 102 and/or the second UE 104 may detect a bandwidth issue and/or a latency issue for the second UE 104. For example, the second UE 104 may be experiencing lower, higher latency, and/or higher jitter, as compared to the first UE 102, which may indicate that a network condition associated with the second network operator 108 has been degraded relative to the first network operator 106. In some cases, the second UE 104 may detect the performance issue, and the second UE 104 may indicate the performance issue to the first UE 102.

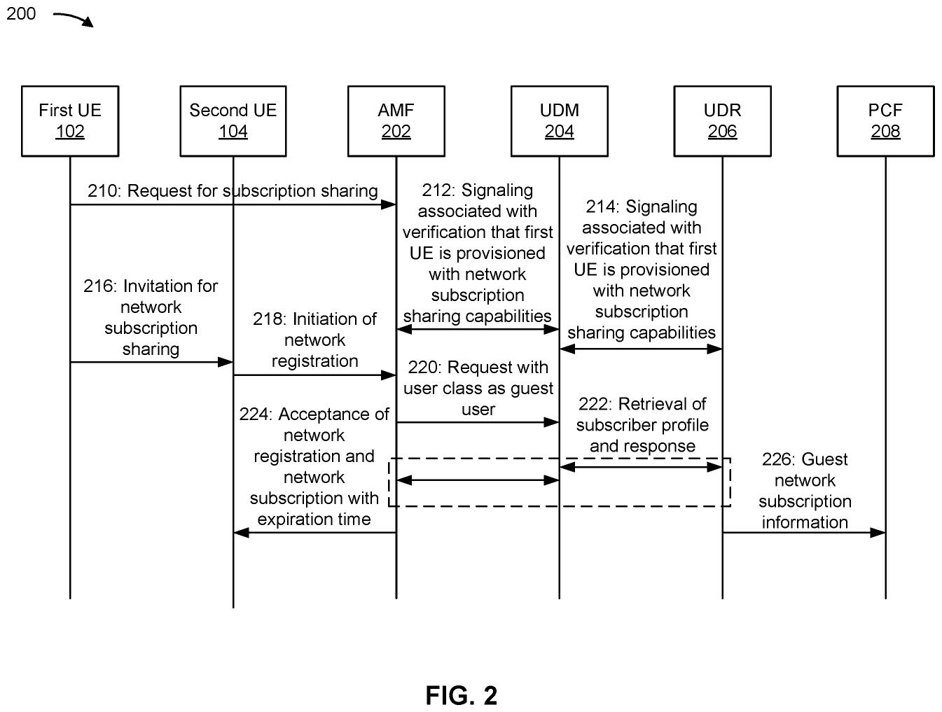

As shown by reference number 118, the first UE 102 may transmit, to the second UE 104, an invitation for network subscription sharing. The first UE 102 may invite the second UE 104 to use the first network operator 106 instead of the second network operator 108. The first UE 102, prior to inviting the second UE 104 to use the first network operator 106, may verify that the first UE 102 has a capability to share its network subscription with the second UE 104, as further described with respect to FIG. 2. The first UE 102 may invite the second UE 104 as a guest to use the first network operator 106. The second UE 104 may be limited to certain features of the first network operator 106, and a usage of the first network operator 106 by the second UE 104 may be for a limited period of time. However, the second UE 104 may be able to temporarily benefit from a network coverage, quality, and/or resilience associated with the first network operator 106 at a time when a performance of the second network operator 108 is degraded.

As shown by reference number 120, the second UE 104 may transmit, to the first UE 102 and/or the first network operator 106, signaling associated with an acceptance of the invention and a registration with the first network operator 106. The registration of the second UE 104 with the first network operator 106 is described in more detail in relation to FIG. 2. The second UE 104 may register with the first network operator 106 and/or unregister with the second network operator 108. The second UE 104 may transmit signaling to the second network operator 108 to indicate that the second UE 104 intends to connect with another network operator for a certain period of time. In some cases, since the second UE 104 may only connect to the first network operator 106 for a limited period of time, the second UE 104 may not actually unregister with the second network operator 108 and/or the second UE 104 may maintain a basic connection with the second network operator 108.

As shown by reference number 122, the second UE 104 may transmit, to the first network operator 106, signaling to cause the second UE 104 to connect to the content/service provider 110 using the first network operator 106. The second UE 104 may connect to the content/service provider 110 using the first network operator 106.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example 200 associated with sharing network subscriptions between UEs. As shown in FIG. 2, example 200 includes a first UE 102, a second UE 104, an AMF 202, a UDM 204, a UDR 206, and a PCF 208. The first UE 102, the second UE 104, the AMF 202, the UDM 204, the UDR 206, and the PCF 208 may correspond to UE 302, AMF 322, UDM 314, UDR 312, and PCF 318, respectively, as shown in FIG. 3. The AMF 202, the UDM 204, the UDR 206, and the PCF 208 may be associated with a first network operator (or first network).

In some implementations, the first UE 102 may be connected to the first network operator and the second UE 104 may be connected to a second network operator (or second network). The first UE 102 and the second UE 104 may be engaging with a content/service provider, where the content/service provider may provide a service, such as an XR service. During a communication between the first UE 102 and the second UE 104, the first UE 102 and/or the second UE 104 may detect a poor performance associated with the second UE 104. For example, the first UE 102 and/or the second UE 104 may detect that the second UE 104 is associated with a decreased bandwidth, increased latency, and/or increased jitter, in relation to the first UE 102. The poor performance associated with the second UE 104 may indicate that a network condition associated with the second network operator has degraded in relation to a network condition associated with the first network operator. In other words, the first network operator may be associated with favorable network conditions, but the second network operator may be associated with unfavorable network conditions, which may negatively affect communications between the first UE 102 and the second UE 104. As a result, a user associated with the first UE 102 may decide to share their network subscription with a user associated with the second UE 104 for a limited duration of time. Alternatively, the first UE 102 and/or the second UE 104 may detect that a performance of the second network operator is less robust than a performance of the first network operator, in which case the user associated with the first UE 102 may decide to share their network subscription with the user associated with the second UE 104 for the limited duration of time.

As shown by reference number 210, the first UE 102 may transmit, to the AMF 202, a request for subscription sharing. The first UE 102 may request, to the AMF 202, to share the first UE's network subscription with the first network operator with the second UE 104, where a sharing of the network subscription may be based on a device setting, an option in a game, and/or a notification that sharing is an option. The first UE 102 may request that the second UE 104 use the first UE's network subscription as a guest. The first UE 102 may indicate information regarding the second UE 104, such as an identifier associated with the second UE 104 and other relevant information.

As shown by reference number 212, the AMF 202 may transmit, to the UDM 204, signaling associated with a verification that the first UE 102 is provisioned with network subscription sharing capabilities. The AMF 202 may verify that the first UE 102 is actually authorized to share its network subscription with other UEs. The AMF 202 may verify with the UDM 204 that the first UE 102 (and the user associated with the UE 102) is provisioned with network subscription sharing capabilities. For example, the AMF 202 may verify that the user associated with the first UE 102 purchased a network subscription sharing price plan, which allows the first UE 102 to share the network subscription. In some implementations, the AMF 202 may verify that the first UE 102 is not authorized to share its network subscription with other UEs. In this case, the AMF 202 (or another network entity) may prompt the first UE 102 to add (e.g., for a fee) an option for network subscription sharing for a single use or for an extended use.

As shown by reference number 214, the UDM 204 may transmit, to the UDR 206, signaling associated with a verification that the first UE 102 is provisioned with network subscription sharing capabilities. The UDM 204 may check with the UDR 206 for network subscription sharing capabilities of the first UE 102 (and the user associated with the first UE 102). When the UDM 204 confirms that the first UE 102 has network subscription sharing capabilities, the UDM 204 may request the UDR 206 to create a guest network subscription profile for the second UE 104 (and for the user associated with the second UE 104). The guest network subscription profile may be associated with a limited subscription, which may have a subset of features as compared to the network subscription associated with the first UE 102. An extent of the subset of features may depend on the network subscription sharing price plan. For example, in some cases, the network subscription sharing price plan may allow the second UE 104 to have almost all of the features of the network subscription associated with the first UE 102. As another example, the network subscription sharing price plan may only allow the second UE 104 to have bare minimum features of the network subscription associated with the first UE 102.

As shown by reference number 216, the first UE 102 may transmit, to the second UE 104, an invitation for network subscription sharing. In some cases, the first UE 102 may wait to receive a confirmation, from the AMF 202, that the first UE 102 is verified to possess the network subscription sharing capabilities and that the guest network subscription profile has been successfully created, before transmitting the invitation to the second UE 104. In other words, the first UE 102 may confirm that the network subscription sharing is allowed before inviting the second UE 104 to use the first UE's network subscription with the first network operator. The invitation may include information that allows the second UE 104 to form a basic connection with the AMF 202, such that the second UE 104 is able to transmit signaling to the AMF 202 to initiate a guest registration with the first network operator. The information may include an identifier associated with the AMF 202.

As shown by reference number 218, the second UE 104 may transmit, to the AMF 202, the signaling to initiate the guest registration with the first network operator. The second UE 104 may initiate the guest registration with a credential that indicates a user class as a guest user. In other words, the user class may be set to “guest user”. The AMF 202 may recognize the credential and skip a network authentication for the second UE 104. The AMF 202 may confirm, based on the signaling from the second UE 104, that the second UE 104 that is sending the credential is the same UE indicated in the information sent by the first UE 102.

As shown by reference number 220, the AMF 202 may send, to the UDM 204, a request for a guest subscription with the user class set to “guest user”. The UDM 204 may recognize the user class and allow the guest subscription for the second UE 104 based on the user class. As shown by reference number 222, the UDM 204 may retrieve the guest network subscription profile for the second UE 104 and respond back to the AMF 202. The UDM 204 may retrieve, from the UDR 206, the guest network subscription profile pertaining to the user class of “guest user”, and the UDM 204 may provide the guest network subscription profile to the AMF 202. The UDR 206 may also provide a subscription expiry time that is associated with the guest network subscription profile. The AMF 202 may receive, from the UDM 204 and/or the UDR 206, the guest network subscription profile with the subscription expiry time.

As shown by reference number 224, the AMF 202 may transmit, to the second UE 104, an indication that the AMF 202 accepts the guest registration of the second UE 104 onto the first network operator. The AMF 202 may provide, to the second UE 104, the guest network subscription, which may allow the second UE 104 to access the first network operator. The guest network subscription may be associated with an expiration time, such that the second UE 104 may only be able to access the first operator network for a limited duration of time. After the second UE 104 receives the indication from the AMF 202, the second UE 104 and the first UE 102 may both be connected to the first operator network. The second UE 104 may remain connected to the first operator network until the guest network subscription expires, at which point the second UE 104 may reconnect with the first operator network.

As shown by reference number 226, the UDR 206 may transmit, to the PCF 208, guest network subscription information. For example, the UDR 206 may provide guest policy subscription information to the PCF 208 when a PDU session is established by the second UE 104.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example environment 300 in which systems and/or methods described herein may be implemented. As shown in FIG. 3, example environment 300 may include a UE 302, a RAN 304, a core network 306, and a data network 330. Devices and/or networks of example environment 300 may interconnect via wired connections, wireless connections, or a combination of wired and wireless connections.

The UE 302 may include one or more devices capable of receiving, generating, storing, processing, and/or providing information, such as information described herein. For example, the UE 302 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 304 may support, for example, a cellular radio access technology (RAT). The RAN 304 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 302. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 304 may transfer traffic between the UE 302 (e.g., using a cellular RAT), one or more base stations (e.g., using a wireless interface or a backhaul interface, such as a wired backhaul interface), and/or the core network 306. The RAN 304 may provide one or more cells that cover geographic areas.

In some implementations, the RAN 304 may perform scheduling and/or resource management for the UE 302 covered by the RAN 304 (e.g., the UE 302 covered by a cell provided by the RAN 304). In some implementations, the RAN 304 may be controlled or coordinated by a network controller, which may perform load balancing, network-level configuration, and/or other operations. The network controller may communicate with the RAN 304 via a wireless or wireline backhaul. In some implementations, the RAN 304 may include a network controller, a self-organizing network (SON) module or component, or a similar module or component. In other words, the RAN 304 may perform network control, scheduling, and/or network management functions (e.g., for uplink, downlink, and/or sidelink communications of the UE 302 covered by the RAN 304).

In some implementations, the core network 306 may include an example functional architecture in which systems and/or methods described herein may be implemented. For example, the core network 306 may include an example architecture of a 5G next generation (NG) core network included in a 5G wireless telecommunications system. While the example architecture of the core network 306 shown in FIG. 3 may be an example of a service-based architecture, in some implementations, the core network 306 may be implemented as a reference-point architecture and/or a 3G core network, among other examples.

As shown in FIG. 3, the core network 306 may include a number of functional elements. The functional elements may include, for example, a network slice selection function (NSSF) 308, a network exposure function (NEF) 310, a UDR 312, a UDM 314, an authentication server function (AUSF) 316, a PCF 318, an application function (AF) 320, an AMF 322, a session management function (SMF) 324, and/or a user plane function (UPF) 326. These functional elements may be communicatively connected via a message bus 328. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 308 may include one or more devices that select network slice instances for the UE 302. The NSSF 308 may allow an operator to deploy multiple substantially independent end-to-end networks potentially with the same infrastructure. In some implementations, each slice may be customized for different services. The NEF 310 may include one or more devices that support exposure of capabilities and/or events in the wireless telecommunications system to help other entities in the wireless telecommunications system discover network services.

The UDR 312 may include one or more devices that provide a converged repository, which may be used by network functions to store data. For example, a converged repository of subscriber information may be used to service a number of network functions. The UDM 314 may include one or more devices to store user data and profiles in the wireless telecommunications system. The UDM 314 may generate authentication vectors, perform user identification handling, perform subscription management, and perform other various functions. The AUSF 316 may include one or more devices that act as an authentication server and support the process of authenticating the UE 302 in the wireless telecommunications system.

The PCF 318 may include one or more devices that provide a policy framework that incorporates network slicing, roaming, packet processing, and/or mobility management, among other examples. The AF 320 may include one or more devices that support application influence on traffic routing, access to the NEF 310, and/or policy control, among other examples. The AMF 322 may include one or more devices that act as a termination point for non-access stratum (NAS) signaling and/or mobility management, among other examples. The SMF 324 may include one or more devices that support the establishment, modification, and release of communication sessions in the wireless telecommunications system. For example, the SMF 324 may configure traffic steering policies at the UPF 326 and/or may enforce UE internet protocol (IP) address allocation and policies, among other examples. The UPF 326 may include one or more devices that serve as an anchor point for intra-RAT and/or inter-RAT mobility. The UPF 326 may apply rules to packets, such as rules pertaining to packet routing, traffic reporting, and/or handling user plane QoS, among other examples. The message bus 328 may represent a communication structure for communication among the functional elements. In other words, the message bus 328 may permit communication between two or more functional elements.

The data network 330 may include one or more wired and/or wireless data networks. For example, the data network 330 may include an Internet Protocol multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

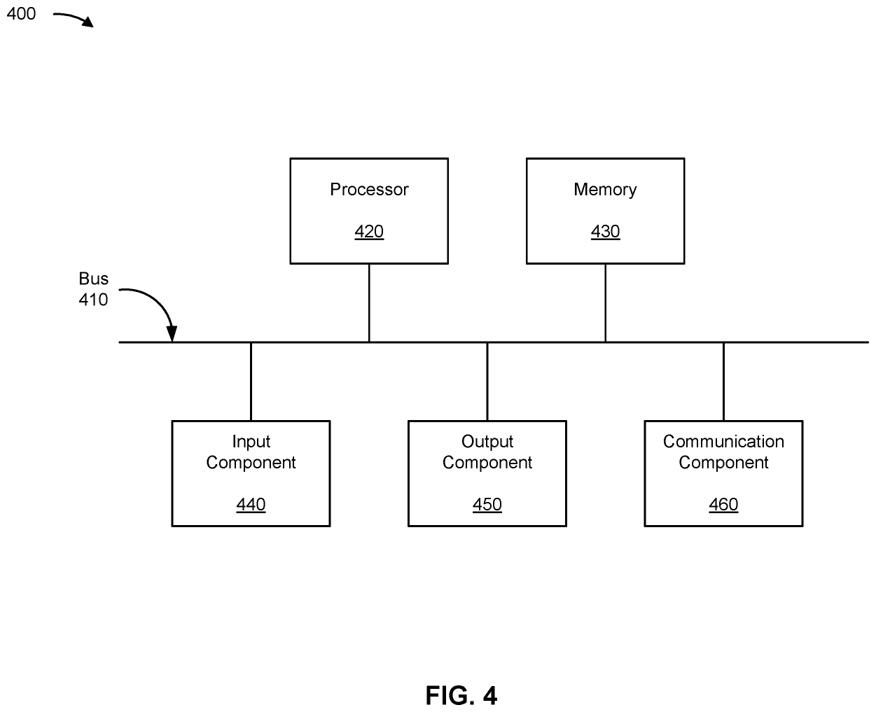

FIG. 4 is a diagram of example components of a device 400 associated with sharing network subscriptions between UEs. The device 400 may correspond to an AMF (e.g., AMF 202 or AMF 322). In some implementations, the AMF may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

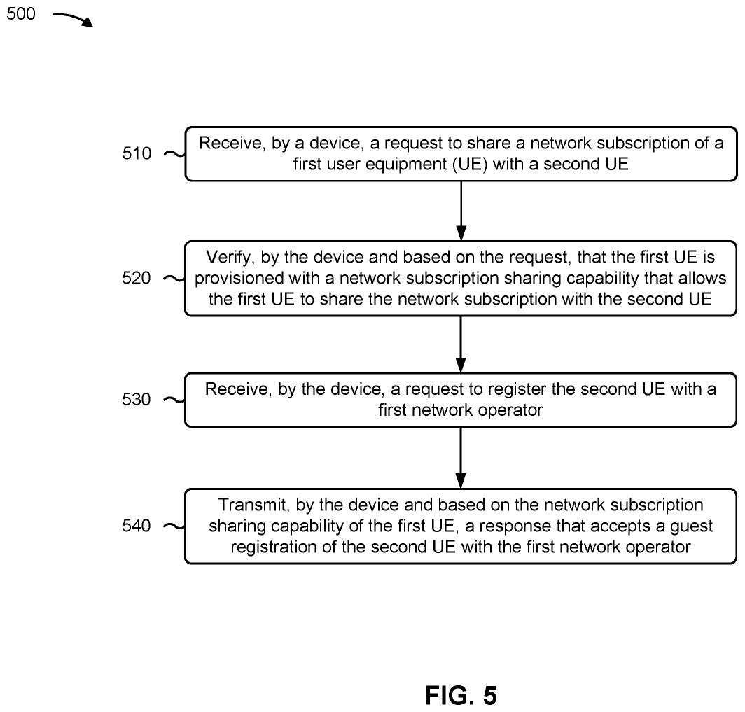

FIG. 5 is a flowchart of an example process 500 associated with sharing network subscriptions between UEs. In some implementations, one or more process blocks of FIG. 5 may be performed by a device (e.g., AMF 202/322). In some implementations, one or more process blocks of FIG. 5 may be performed by another entity or a group of entities separate from or including the device (e.g., UDM 204/314, UDR 206/312, or PCF 208/318). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, by the device, a request to share a network subscription of a first UE with a second UE (block 510). The first UE may be associated with a first network operator (or first network) and the second UE may initially be associated with a second network operator (or second network). The second network operator may be associated with a poor network condition in relation to the first network operator. The poor network condition may be associated with bandwidth, latency, and/or jitter. The first UE may request that the network subscription of the first UE be dynamically shared or shared in an on-demand manner with the second UE for a duration of a session, where the request may be based on an invitation provided by the first UE to the second UE.

As shown in FIG. 5, process 500 may include verifying, by the device and based on the request, that the first UE is provisioned with a network subscription sharing capability that allows the first UE to share the network subscription with the second UE (block 520). The device may check whether the network subscription sharing capability exists for the first UE. The device may check that the first UE is associated with a purchased sharing price plan that allows the network subscription sharing by the first UE.

As shown in FIG. 5, process 500 may include receiving, by the device, a request to register the second UE with the first network operator (block 530). The request may include a credential that indicates a user class as a guest user. The device may skip an authentication process for the second UE based on the credential that indicates the user class as the guest user. The request from the second UE may be received after the first UE invites the second UE to connect to the first network operator as a guest.

As shown in FIG. 5, process 500 may include transmitting, by the device and based on the network subscription sharing capability of the first UE, a response that accepts a guest registration of the second UE with the first network operator (block 540). The response may provide a guest network subscription that allows the second UE to connect to the first network operator. The guest network subscription may be associated with an expiration time. The device may create a guest network subscription profile for the second UE. The guest network subscription profile may be associated with the guest network subscription. The guest network subscription may be associated with a limited set of features as compared to the network subscription of the first UE. The device may connect the second UE to a content or service provider based on the guest network subscription. The content or service provider may be associated with an XR service.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to share a network subscription of a first user equipment (UE) with a second UE, wherein the first UE is associated with a first network operator and the second UE is associated with a second network operator;
verifying, by the device and based on the request, that the first UE is provisioned with a network subscription sharing capability that allows the first UE to share the network subscription with the second UE;
receiving, by the device, a request to register the second UE with the first network operator, wherein the request includes a credential that indicates a user class as a guest user; and
transmitting, by the device and based on the network subscription sharing capability of the first UE, a response that accepts a guest registration of the second UE with the first network operator, wherein the response provides a guest network subscription that allows the second UE to connect to the first network operator.

2. The method of claim 1, further comprising:
creating, by the device, a guest network subscription profile for the second UE, wherein the guest network subscription profile is associated with the guest network subscription, and the guest network subscription is associated with a limited set of features.

3. The method of claim 1, further comprising:
bypassing, by the device, an authentication process for the second UE based on the credential that indicates the user class as the guest user.

4. The method of claim 1, further comprising:
connecting, by the device, the second UE to a content or service provider based on the guest network subscription.

5. The method of claim 1, wherein the guest network subscription is associated with an expiration time.

6. The method of claim 1, wherein the first network operator is associated with a first set of network condition and the second network operator is associated with a second set of network conditions, wherein the first set of network conditions and the second set of network conditions are associated with one or more of: bandwidth, latency, or jitter.

7. The method of claim 1, wherein the network subscription of the first UE is shared on-demand with the second UE for a duration of a session based on an invitation by the first UE.

8. A device, comprising:
one or more processors configured to:
receive a request to share a network subscription of a first user equipment (UE) with a second UE, wherein the first UE is associated with a first network and the second UE is initially associated with a second network;
verify, based on the request, that the first UE is provisioned with a network subscription sharing capability that allows the first UE to share the network subscription with the second UE;
receive a request to register the second UE with the first network, wherein the request includes a credential that indicates a user class as a guest user; and
transmit, based on the network subscription sharing capability of the first UE, a response that accepts a guest registration of the second UE with the first network, wherein the response provides a guest network subscription that allows the second UE to connect to the first network.

9. The device of claim 8, wherein the one or more processors are further configured to:
create a guest network subscription profile for the second UE, wherein the guest network subscription profile is associated with the guest network subscription, and the guest network subscription is associated with a limited set of features as compared to the network subscription of the first UE.

10. The device of claim 8, wherein the one or more processors are further configured to:
skip an authentication process for the second UE based on the credential that indicates the user class as the guest user.

11. The device of claim 8, wherein the one or more processors are further configured to:
connect the second UE to a content or service provider based on the guest network subscription, wherein the content or service provider is associated with an extended reality (XR) service.

12. The device of claim 8, wherein the guest network subscription is associated with an expiration time.

13. The device of claim 8, wherein the first network operator is associated with a first set of network condition and the second network operator is associated with a second set of network conditions, wherein the first set of network conditions and the second set of network conditions are associated with one or more of: bandwidth, latency, or jitter.

14. The device of claim 8, wherein the network subscription of the first UE is shared on-demand with the second UE for a duration of a session based on an invitation by the first UE.

15. The device of claim 8, wherein the device is an access and mobility management function (AMF) device in a wireless network.

16. A non-transitory computer-readable medium storing a set of instructions, the set of instructions comprising:
one or more instructions that, when executed by one or more processors of a device, cause the device to:
receive a request to share a network subscription of a first user equipment (UE) with a second UE, wherein the first UE is associated with a first network operator and the second UE is initially associated with a second network operator;
verify, based on the request, that the first UE is associated with a network subscription sharing capability that allows the first UE to share the network subscription with the second UE;
receive a request to register the second UE with the first network operator, wherein the request includes a credential that indicates a user class as a guest user; and
transmit, based on the network subscription sharing capability of the first UE, a response that accepts a guest registration of the second UE with the first network operator, wherein the response provides a guest network subscription that allows the second UE to connect to the first network operator.

17. The non-transitory computer-readable medium of claim 16, wherein the one or more instructions, when executed by the one or more processors, further cause the device to:
create a guest network subscription profile for the second UE, wherein the guest network subscription profile is associated with the guest network subscription, and the guest network subscription is associated with a limited set of features as compared to the network subscription of the first UE;
skip an authentication process for the second UE based on the credential that indicates the user class as the guest user; and
connect the second UE to a content or service provider based on the guest network subscription, wherein the content or service provider is associated with an extended reality (XR) service.

18. The non-transitory computer-readable medium of claim 16, wherein the guest network subscription is associated with an expiration time.

19. The non-transitory computer-readable medium of claim 16, wherein the second network operator is associated with a poor network condition in relation to the first network operator, and the poor network condition is associated with one or more of: bandwidth, latency, or jitter.

20. The non-transitory computer-readable medium of claim 16, wherein the network subscription of the first UE is shared on-demand with the second UE for a duration of a session based on an invitation by the first UE.
